(19) United States
(12) Patent Application Publication
(10) Pub. No.: US 2022/0397751 A1
(43) Pub. Date: Dec. 15, 2022

(54) RE-SCAN MICROSCOPE SYSTEM AND METHOD

(71) Applicant: CONFOCAL.NL B.V., Amsterdam (NL)

(72) Inventor: Erik Martinus Marie Manders, Amsterdam (NL)

(21) Appl. No.: 17/622,443

(22) PCT Filed: Jun. 26, 2020
(86) PCT No.: PCT/NL2020/050420

§ 371 Date: Dec. 23, 2021

(30) Foreign Application Priority Data
Jun. 26, 2019 (NL) 2023384

(51) Int. Cl. G02B 21/00; G02B 26/12

(52) U.S. Cl. CPC G02B 21/0048; G02B 21/0032; G02B 21/0076; G02B 21/008; G02B 21/006; G02B 26/12

(57) ABSTRACT

A re-scan microscope for forming an image of a sample is disclosed. The system comprises an illumination optical system for directing, and optionally focusing, illumination light at the sample herewith providing an illumination light spot at the sample. The illumination light spot causes emission light from the sample. The microscope system further comprises a detection optical system for focusing at least part of the emission light onto an imaging plane of an imaging system herewith causing an emission light spot on the imaging plane. The microscope system also comprises a rotatable element for, when rotating, moving the illumination light spot over and/or through the sample and simultaneously moving the emission light spot over said imaging plane of the imaging system. The rotatable element comprises at least two reflective surfaces.

### CROSS-REFERENCE TO RELATED APPLICATION

This Application is a Section 371 National Stage Application of International Application No. PCT/NL2020/050420, filed Jun. 26, 2020 and published as WO/2020/263094 A1 on Dec. 30, 2020, in English, the contents of which are hereby incorporated by reference in their entirety.

### FIELD OF THE INVENTION

This disclosure relates to a re-scan microscope system. In particular to a re-scan microscope system that comprises a rotatable element that is configured to rotate over 360 degrees.

### BACKGROUND

A re-scan confocal microscope is known from De Luca G M, Breedijk R M, Brandt R A, et al. Re-scan confocal microscopy: scanning twice for better resolution. Biomed Opt Express. 2013; 4(11):2644-2656. Published 2013 Oct. 25. doi:10.1364/BOE.4.002644, hereinafter referred to as “De Luca”. This microscope has two units: 1) a standard confocal microscope with a set of scanning mirrors which have double function: scanning the excitation light and de-scanning the emission light, and 2) a re-scanning unit that “writes” the light that passes a pinhole onto a CCD-camera. By controlling the ratio of the angular amplitude of the respective scanning mirror and rescanning mirror, the properties of the microscope can be controlled.

In such a re-scan system it is important that the scanning and rescanning mirrors perform synchronized movements. Preferably, each sweep of the scanning mirror exactly begins, respectively ends, at the same time as a corresponding sweep of the rescanning mirror begins, respectively ends. If the scanning and re-scanning mirror move asynchronously, the obtained image will have a low quality. As will be understood, at higher scan speeds, the mirrors move faster and the acceptable margin of error for the synchronization becomes smaller. Since the degree of synchronization of the mirrors in the system of De Luca is limited, the scan speed is also limited.

Therefore, there is a desire in the art for a re-scan microscope that can scan a sample at higher scan speeds while maintaining synchronization of the scanning and re-scanning mirrors.

Gregor et al, Image scanning microscopy, Current Opinion in Chemical Biology 2019, Volume 51, page 74-83 discloses the basic principles of Image Scanning Microscopy and in particular discloses a re-scan image scanning microscope that comprises a scanning mirror and re-scanning mirror.

Li et al, The Journal of Investigative Dermatology, volume 125:798-804, 2005 discloses a dual contrast confocal microscope. Herein, a reflected light channel is formed by a laser diode aimed through a beamsplitter cube and onto a rotating polygonal mirror for fast scanning. The light then goes to a galvo scanner and the objective lens. The incident light is scattered by the tissue and the reflected light retraces the optical path. A bs diverts the reflected light to a confocal detector. The fluorescence channel has an argon laser (Ar+) coupled to the scanner; a dichroic mirror (dm) diverts the excitation light to a combining dichroic mirror (cd) that aligns the fluorescence excitation light (488 nm) to the reflectance light (830 nm). After the cd the two beams share the same optical path to the sample and back. The returning fluorescence signal is diverted by the combining dichroic (cd) through the dichroic mirror (dm), onto the barrier filter (bf) that eliminates any remaining excitation light, and to a second confocal detector (FCM).

Hari P. Paudel. Yookyung Jung, Anthony Raphael. Clemens Alt, Juwell Wu, Judith Runnels, and Charles P. Lin “In vivo flow cytometry for blood cell analysis using differential epi-detection of forward scattered light”, Proc. SPIE 10497. Imaging. Manipulation. and Analysis of Biomolecules, Cells, and Tissues XVI, 104970G (20 Feb. 2018) discloses a flow cytometer comprising a 36 facet polygon scanner.

### SUMMARY

To this end a re-scan microscope for forming an image of a sample is disclosed. The system comprises an illumination optical system for directing, and optionally focusing, illumination light at the sample herewith providing an illumination light spot at the sample. The illumination light spot causes emission light from the sample. The microscope system further comprises a detection optical system for focusing at least part of the emission light onto an imaging plane of an imaging system herewith causing an emission light spot on the imaging plane. The microscope system also comprises a rotatable element for, when rotating, moving the illumination light spot over and/or through the sample and simultaneously moving the emission light spot over said imaging plane of the imaging system. The rotatable element comprises at least two reflective surfaces.

Because a single rotatable element is used for both scanning the illumination light spot over and/or through the sample and re-scanning the emission light spot over the imaging plane, good synchronization between the respective movements of the illumination light spot and emission light spot can be readily achieved, irrespective of the angular velocity with which the rotatable element is rotating for moving the light spots. Therefore, the re-scan microscope system enables to scan at high speeds while still maintaining synchronization.

The at least two reflective surfaces are, optionally, non-parallel, which may be understood as that they are oriented at a nonzero and non-180 degrees angle with respect to each other. A normal vector of a reflective surface may be understood to be a vector that is perpendicular to the reflective surface, has its initial point at the reflective surface and points outwards, i.e. to the side of the surface where the incident and reflected light are. The angle between two normal vectors of two respective reflective surfaces may be understood to be the smallest angle that the two vectors would make when they would be both positioned in the standard position. i.e. with their initial points at the origin in the Cartesian coordinate system. In general, an angle between two surfaces may be understood to be the angle between their respective normal vectors. Thus, stating that two surfaces are oriented at an angle of a particular size with respect to each other may be understood to be equivalent to stating that the angle between the respective normal vectors of the two surfaces is of said particular size.

A reflective surface may be understood to relate to any reflective element, e.g. mirrors, splitters, prisms, etc. A reflective multilayer coating is for example also to be regarded as a reflective surface as used herein. A reflective surface may be understood to provide an intended reflection. A reflective surface as used herein may be configured to partially reflect light. In an example, a reflective surface only reflects a particular wavelength range and/or only a particular polarization direction.

In an embodiment, the rotatable element is configured to rotate over an angle of at least 90 degrees about an axis of rotation, preferably to rotate over an angle of at least 180 degrees, more preferably over an angle of at least 360 degrees, most preferably configured to rotate infinitely, about an axis of rotation. This embodiment allows high speed, energy efficient scanning because the rotatable element can be brought into its initial position without having to change angular momentum. Conventional scanning mirrors, such as the scanning mirror and re-scanning mirror of De Luca, need, after a scanning movement from an initial scanning position to an end scanning position, to come to a halt and return to the initial scanning position. Because of this, the speed with which these mirrors can pivot is limited. In such embodiment, the two reflective surfaces may or may not be parallel.

In an embodiment, the rotatable element is configured to consecutively make a plurality of full rotations, preferably the rotatable element having a substantially constant angular momentum when making said plurality of full rotations.

In an embodiment, the rotatable element comprises a first reflective surface and a second reflective surface. In such embodiment, the re-scan microscope system is configured such that, in use, during a rotation of the rotatable element, the first reflective surface reflects the illumination light throughout a first time period and changes orientation during said first time period for moving the illumination light spot over and/or through the sample.

Since the first and second reflective surface are part of the same rotatable element, their orientation with respect to each other and position with respect to each other may be fixed and move together on rotation of the rotatable element. Thus, any movement of the first reflective surface causes the first and second reflective surfaces to move together. This holds at any angular velocity with which the rotatable element is rotating. Therefore, the present re-scan microscope enables high speed, synchronous movements of the first and second reflective surfaces and enables to scan samples at high speeds.

It should be understood that the reflective surfaces of the rotatable element may change orientation due to the rotation of the rotatable element. The reflective surfaces are preferably not circumferentially curved with respect to the rotational axis of the rotatable element, in particular being plane in a tangential direction with respect to the rotational axis.

A reflective surface of the rotatable element reflecting the illumination light throughout a time period and changing orientation during this time period for moving the illumination light spot over and/or through the sample may be referred to as the reflective surface performing a scanning function. Further, in this situation, the illumination light may be said to be scanned by the reflective surface.

A reflective surface reflecting emission light during a time period and changing orientation during this time period for moving the emission light spot over the imaging plane may be referred to as the reflective surface performing a re-scanning function. Further, in this situation, the emission light may be said to be re-scanned by the reflective surface.

Preferably, the rotational axis of the rotatable element does not cross the first nor the second reflective surface.

In an embodiment, the re-scan microscope system is configured such that, in use, during said first time period, the second reflective surface reflects the emission light and changes orientation during said first time period for moving the emission light spot over the imaging plane. In such embodiment, it may be understood as that the first reflective surface is used as a scanning mirror (and possibly de-scanning mirror) while the second reflective surface is used as a re-scanning mirror.

Such embodiment enables good separation of illumination light and emission light. It should be understood that some of the illumination light that is incident onto the sample may be scattered back. This backscattered illumination light may be significantly stronger, even several orders of magnitude stronger, e.g. a million times stronger, than the emission light. Hence, it is desired that such backscattered illumination light does not reach the imaging system. This can be readily achieved by using one mirror as scanning mirror and another as re-scanning mirror.

In such embodiment, the first and second reflective surface may be oriented at a nonzero and non-180 degrees angle with respect to each other. This allows illumination light and emission light to approach the rotatable element while traveling substantially in parallel directions. Due to the non-zero angle of the reflective surfaces, the illumination light and emission light can for example be reflected in different, optionally even substantially opposite directions, the illumination light towards the sample and the emission light towards the imaging system. This allows to position the imaging system and sample at different, e.g. opposite, sides of the rotatable element without having to introduce further mirrors for guiding the illumination light towards the sample and/or for guiding the emission light towards the imaging system, thus allowing compact set-ups. Further, because the angle between the first and second reflective surfaces is non-180 degrees, there is no need to completely reroute the emission light, after it has been de-scanned by the rotatable element, around the rotatable element, which would require additional mirrors and relatively long optical paths between such mirrors.

In an embodiment, the re-scan microscope system is configured such that, in use, at least part of the illumination light, after it has been scanned by a reflective surface of the rotatable element, is not incident on a mirror before being incident on the sample. This embodiment also allows for compact optical setups.

In an embodiment, the re-scan microscope system is configured such that, in use, the emission light, after it has been re-scanned by a reflective surface of the rotatable element, is not incident on a mirror before being incident on the imaging plane of the imaging system. This embodiment also allows for compact optical setups.

In an embodiment wherein the first reflective surface is used as a scanning mirror while the second reflective surface is used as a re-scanning mirror, the re-scan microscope system is configured such that, in use, during the rotation of the rotatable element, the second reflective surface reflects the illumination light throughout a second time period and changes orientation during said second time period for moving the illumination light spot over and/or through the sample and configured such that, in use, during said second time period, a further reflective surface of the rotatable element reflects the emission light and changes orientation during said second time period for moving the emission light spot over the imaging plane. Herein, the further reflective surface may be the first reflective surface.

In such embodiment, the second reflective surface, during a rotation of the rotatable element, both performs a scanning function and a rescanning function and is thus efficiently used.

The first and second time periods may be understood to be non-overlapping time periods. The first and second reflective surfaces may be understood to be different surfaces.

In an embodiment, the rotatable element may comprise a third reflective surface and the re-scan microscope may be configured such that, in use, during the rotation of the rotatable element, the third reflective surface reflects the illumination light throughout a third time period and changes orientation during said third time period for moving the illumination light spot over and/or through the sample and configured such that, during said third time period, another reflective surface of the rotatable element reflects the emission light and changes orientation during said third time period for moving the emission light spot over the imaging plane. In such embodiment, the first and third reflective surface are non-parallel and, optionally, the first and second reflective surface are oriented at an angle of 180 degrees with respect to each other. The third time period may occur between the first and second time period mentioned above.

In such embodiment, the angle over which the rotatable element has to rotate before a next line is scanned over the sample/imaging plane is relatively small, which benefits the scan speed.

In an embodiment, the re-scan microscope system is configured such that, in use, during said first time period, the first reflective surface reflects the emission light and changes orientation during said first time period for moving the emission light spot over the imaging plane and such that, in use, during the rotation of the rotatable element, the second reflective surface reflects the illumination light throughout a second time period and changes orientation during said second time period for moving the illumination light spot over and/or through the sample.

In such embodiment, it may be understood as that the first reflective surface is simultaneously used both as a scanning mirror (and de-scanning mirror) and re-scanning mirror.

In such embodiment, the first and second reflective surface may be oriented at a nonzero and non-180 degrees angle with respect to each other, so that the rotatable element does not have to rotate over 180 degrees after the first reflective surface has performed the double scanning and re-scanning function before the second reflective surface can perform the double scanning and re-scanning function, which enables high scan speeds. In particular, more scan lines can be written per full rotation of the rotatable element.

In an embodiment, wherein the first reflective surface is simultaneously used both as a scanning mirror and re-scanning mirror, the re-scan microscope system is configured such that, in use, during said second time period, the second reflective surface reflects emission light and changes orientation during said second time period for moving the emission light spot over the image plane.

In such embodiment, both the first and second reflective surface each simultaneously perform a double scanning and re-scanning function during a rotation the rotatable element, the first reflective surface during the first time period and the second reflective surface during the second time period.

In an embodiment, the rotatable element comprises a rotatable polygon scanner comprising a plurality of reflective facets, wherein the first reflective surface is a first facet of the plurality of reflective facets and the second reflective surface is a second facet of the plurality of reflective facets.

The polygon scanner may have any number of facets, each facet being a reflective surface that, during a rotation, performs a scanning function and/or re-scanning function.

In an embodiment, the re-scan microscope system is configured to move the illumination light spot over and/or through the sample at a first velocity and move the emission light spot over the imaging plane at a second velocity, such that the second velocity is different from, preferably higher than, a baseline velocity. The baseline velocity is defined as the first velocity multiplied by the optical magnification of the re-scan microscope system. This embodiment allows to improve the resolution of the formed image of the sample.

The optical magnification of the microscope system may be understood to be the magnification of the sample that arises because of the different lenses in the microscope system and does not include any magnification that arises because of the second velocity being higher than the baseline velocity. The latter magnification may be referred to as mechanical magnification as opposed to optical magnification. As such, the optical magnification of the microscope system that defines the baseline velocity may be understood to relate to the magnification of the illumination light spot, for example in the sense that it relates to a ratio between a dimension, e.g. a diameter, of the emission light spot as projected onto the imaging plane of the imaging system and a corresponding dimension, e.g. also the diameter, of the illumination light spot at the sample.

In an embodiment, the second velocity is approximately twice as high as the baseline velocity. This advantageously optimizes the resolution of the to be formed image.

In an embodiment, the re-scan microscope system comprises an objective configured to gather the emission light from the sample and focus the emission light on a primary image plane of the re-scan microscope system. In such embodiment, the detection optical system is configured to image images in the primary image plane onto the imaging plane of the imaging system. The primary image plane may be understood to be the first image plane that the emission light passes on its way to the imaging plane of the imaging system.

In one embodiment, the detection optical system is configured to image images in the primary image plane onto the imaging plane of the imaging system with an optical magnification of approximately 0.5. This embodiment allows to obtain a sweep factor of 2 as described in De Luca while the scanning and re-scanning mirrors have equal scanning amplitudes.

In an embodiment, the re-scan microscope system is configured such that, in use, an angle between a travel direction of the illumination light that is incident on the rotatable element and a travel direction of the emission light that is incident on the rotatable element for moving the emission light spot over the imaging plane is less than 90 degrees, preferably less than 60 degrees, more preferably less than 30 degrees, most preferably approximately zero degrees. This embodiment allows a very compact setup of the re-scan microscope system.

A travel direction of light may be represented by a vector. The angle between two travel directions may be understood to refer to the smallest angle that the respective vectors of the travel directions would make when the vectors would be positioned in the standard position. i.e. with their initial points at the origin in the Cartesian coordinate system.

In an embodiment, the rotatable element is configured to reflect the illumination light in a first variable direction and to reflect the emission light for moving the emission light spot over the imaging plane in a second variable direction, wherein the angle between the first and second variable direction is larger than 90 degrees, preferably larger than 120 degrees, more preferably larger than 150 degrees, most preferably approximately 180 degrees.

This embodiment advantageously enables to position the imaging system and sample at opposite sides of the rotatable element, which allows for a compact optical setup.

Preferably, the first and second variable directions lie in a radial surface around the rotational axis of the rotatable element or make relatively small angles, such as at most 10 degrees, with respect to such radial surface. A radial surface may be understood to be a surface that is perpendicular to the axis of rotation. In other words, the first direction, respectively second direction, preferably does not vary such that the angle between a radial surface around the rotational axis of the rotatable element and the first, respectively second, direction becomes higher than 10 degrees. Again, a direction can be represented by a vector. The angle between a direction and a surface may be understood to be the smallest angle that the vector representing this direction makes with the surface when the initial point of the vector would be positioned at the surface.

In an embodiment, the microscope system comprises an aperture, such as a pinhole or slit, for passing emission light and an optical system for focusing the emission light onto the aperture. This embodiment enables the re-scan microscope system to perform optional sectioning.

One aspect of this disclosure relates to a method for forming an image of a sample using a re-scan microscope system. The re-scan microscope system comprises an illumination optical system for directing, and optionally focusing, illumination light at the sample therewith providing an illumination light spot at the sample, the illumination light spot causing emission light from the sample. The re-scan microscope system further comprises a detection optical system focusing at least part of the emission light onto an imaging plane of an imaging system herewith causing an emission light spot on the imaging plane. The re-scan microscope system further comprises a rotatable element comprising at least two non-parallel reflective surfaces. The method comprises rotating the rotatable element for moving the illumination light spot over and/or through the sample and simultaneously moving the emission light spot over said imaging plane of the imaging system. The re-scan microscope system may be any of the re-scan microscope systems as described herein.

Optionally, the method comprises rotating the rotatable element over an angle of at least 90 degrees about an axis of rotation, preferably over an angle of at least 180 degrees, more preferably over an angle of at least 360 degrees, most preferably over multiple full rotations.

Optionally, the method comprises generating the illumination light.

Optionally, the method comprises incrementally rotating a further scan system, such as a y-axis scan system, multiple times during one full rotation of the rotatable element so that a desired area of the sample is scanned, for example as depicted in FIGS. 6A and 6B.

One aspect of this disclosure relates to a computer-implemented method comprising the step of causing the re-scan microscope system to perform the method for forming an image of a sample as described herein.

One aspect of this disclosure relates to a computer comprising a computer readable storage medium having computer readable program code embodied therewith, and a processor, preferably a microprocessor, coupled to the computer readable storage medium, wherein responsive to executing the computer readable program code, the processor is configured to perform the method computer-implemented method as described herein.

One aspect of this disclosure relates to a computer program or suite of computer programs comprising at least one software code portion or a computer program product storing at least one software code portion, the software code portion, when run on a computer system, being configured for executing the computer-implemented method described herein.

One aspect of this disclosure relates to a non-transitory computer-readable storage medium storing at least one software code portion, the software code portion, when executed or processed by a computer, is configured to perform the computer-implemented described herein.

As will be appreciated by one skilled in the art, aspects of the present invention may be embodied as a system, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied. e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Moreover, a computer program for carrying out the methods described herein, as well as a non-transitory computer readable storage-medium storing the computer program are provided. A computer program may, for example, be downloaded (updated) to the existing data processing systems or be stored upon manufacturing of these systems.

Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1 schematically shows a re-scan microscope system according to an embodiment;

FIG. 2 schematically shows, in three dimensions, a re-scan microscope system according to an embodiment;

FIGS. 3A-3C illustrate scanning and re-scanning as performed by the rotatable element during a rotation according to an embodiment, wherein the scanning and re-scanning functions are performed by different reflective surfaces;

FIGS. 4A-4C illustrate scanning and re-scanning as performed by the rotatable element during a rotation according to an embodiment, wherein the scanning and re-scanning functions are performed by a single reflective surface;

FIGS. 5A-5C illustrate scanning and re-scanning as performed by the rotatable element during a rotation according to an embodiment, wherein the scanning and re-scanning functions are performed by two parallel reflective surfaces;

FIGS. 6A-6B illustrate the movement of illumination light in a primary image plane and corresponding movement of the emission light spot in the imaging plane of the imaging system according to an embodiment;

FIGS. 7A-7B show rotatable elements according to two different embodiments;

FIG. 8 shows a data processing system according to an embodiment that may be used in a re-scan microscope system according to an embodiment.

### DETAILED DESCRIPTION OF THE DRAWINGS

In the figures, identical reference numerals indicate identical or similar elements.

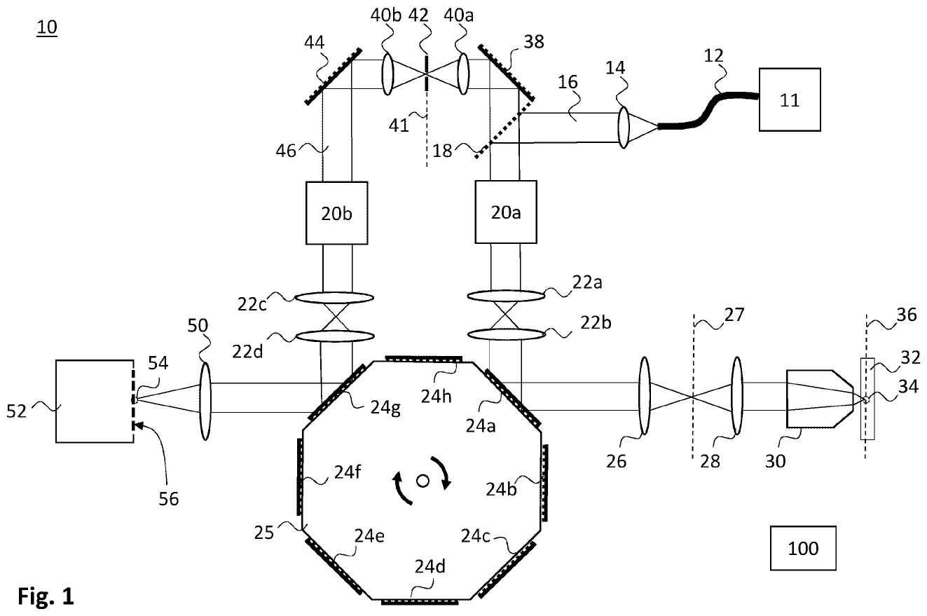

FIG. 1 schematically shows a re-scan microscope system 10 for forming an image of a sample 32 according to one embodiment. A light source, such as a laser 11, generates illumination light 16. An optical fiber cable 12 may be used to guide the illumination light 16 from light source 11 to the re-scan microscope system 10. A collimating lens 14 converts the divergent illumination light as output by the optical fiber cable 12 into a parallel beam.

The system 10 comprises an illumination optical system for directing the illumination light 16 at the sample. In the depicted embodiment, the illumination optical system comprises a dichroic mirror 18, a y-axis scan system 20a, relay optics comprising lenses 22a and 22b, a first reflective surface 24a, such as a mirror, of a rotatable element 25, a scan lens 26, a tube lens 28 and an objective 30. The illumination optical system is configured to direct, and optionally focus, the illumination light 16 at the sample. Herewith, an illumination light spot 34 is provided at the sample 32. In this example, the illumination light spot is positioned in plane 36 through the sample 32. The sample may be fluorescently labelled and may be a biological sample.

The illumination light spot 34 at the sample 32 causes emission light 46 from the sample. In one example, the illumination light spot causes optical excitations in the sample 32, which optical excitations, upon decaying to lower energy levels, cause the emission light. In this example, the illumination light 16 may be regarded as excitation light and the emission light as fluorescent light. In another example, the illumination light spot causes emission light from the sample 32 in the sense that the illumination light is reflected by the sample 34. The reflected light may also be regarded as emission light 46, in particular as reflection emission light.

The re-scan microscope system 10 further comprises a detection optical system for focusing the emission light onto an imaging plane 56 of an imaging system 52. Herewith an emission light spot 54 is caused on the imaging plane 56. The imaging system may be a camera, such as a CCD camera. The imaging plane preferably comprises a plurality of pixels that are arranged in a predefined manner. e.g. in a 2D lattice. In the depicted embodiment, the detection optical system comprises scan lens 26, reflective surface 24a, relay lenses 22a and 22b, y-axis scan system 20a, mirror 38, a pinhole 42, lenses 40a and 40b positioned on either side of pinhole 42, mirror 44, y-axis scan unit 20b, relay lenses 22c and 22d, a second reflective surface 24g and re-scan lens 50. However, it should be appreciated that the depicted detection optical system is merely an example and that the detection optical system used for the invention may in principle comprise less, or more, optical elements, such as mirrors and lenses, than depicted in FIG. 1.

The depicted embodiment comprises a dichroic mirror 18 that is configured to reflect illumination light 16 travelling towards the sample 32 and to pass emission light 46 travelling from sample 32 to the imaging system 52.

The rotatable element 25 is configured to rotate over an angle of at least 360 degrees and herewith move the illumination light spot 34, provided by the illumination optical system, over and/or through the sample 32. In the depicted embodiment, the illumination light spot 34 moves over plane 36 that lies through sample 32. The rotatable element 25 also performs another function. Due to its rotation, the rotatable element 25 namely simultaneously moves the emission light spot 54, caused by the detection optical system, over the imaging plane 56. In one embodiment, the rotatable element 25 is configured to consecutively make a plurality of full rotations. Preferably, the rotatable element can rotate infinitely.

For each rotation of the rotatable element, each reflective surface of the rotatable element may perform a scanning function and/or a re-scanning function at least once, preferably once.

It should be understood that the reflective surface 24a may both scan the illumination light so that the illumination light spot moves over and/or through the sample 32 as well as de-scan the emission light 46 from the sample 32 so that a static light beam of emission light is formed between reflective surface 24a and reflective surface 24g. Static may be understood as not moving with respect to the rotational axis 60 of the rotatable element 25.

Each reflective surface 24a-24h of the rotatable element 25 has a normal vector. Preferably, the respective normal vectors of the reflective surfaces lie in the same plane. Preferably, this plane is perpendicular to the axis of rotation of the rotatable element. In one embodiment, the normal vectors of the reflective surfaces make equal angles with respect to each other.

In an embodiment, adjacent reflective surfaces of the rotatable element are oriented at an angle with respect to each other that is smaller than 90 degrees, i.e. the respective normal vectors of the adjacent surfaces make an angle with respect to each other that is smaller than 90 degrees. Note that in the depicted example, the normal vectors are directed away from the rotational axis of the rotatable element.

The reflective surfaces may be fixed onto the rotatable element. In an embodiment, the orientation of each of the reflective surfaces with respect to the rotatable element may be adaptable in order to ease alignment of the optical system.

In an embodiment, the rotatable element 25 comprises a rotatable polygon scanner comprising a plurality of reflective facets 24a. 24g, wherein the first reflective surface 24a is a first facet 24a of the plurality of reflective facets and the second reflective surface 24g is a second facet 24g of the plurality of reflective facets. In principle, the polygon scanner may comprise any number of facets. In the depicted embodiment, other facets are indicated by 24b. 24c. 24d, 24e, 24f. 24h.

The depicted re-scan microscope system 10 is configured such that, in use, during a rotation of the rotatable element 25, the first reflective surface 24a reflects the illumination light 16 throughout a first time period and changes orientation during said first time period for moving the illumination light spot 34 over and/or through the sample 32. In one embodiment, the re-scan microscope system 10 is configured such that, in use, during said first time period, the second reflective surface 24g reflects the emission light 46 and changes orientation during said first time period for moving the emission light spot 54 over the imaging plane 56.

In the depicted embodiment, the re-scan microscope system 10 is configured such that, in use, during the rotation of the rotatable element 25, the second reflective surface 24g reflects the illumination light 16 throughout a second time period and changes orientation during said second time period for moving the illumination light spot 34 over and/or through the sample 32 and configured such that, during said second time period, a further reflective surface 24e of the rotatable element 25 reflects the emission light 46 and changes orientation during said second time period for moving the emission light spot 54 over the imaging plane 56.

Preferably, the point where the illumination light 16 reflects from the first reflective surface lies in a focal plane of scan lens 26 so that the illumination light spot 34 neatly moves over plane 36. Also, preferably, the point where the emission light reflects from the second reflective surface lies in a focal plane of re-scan lens 50 so that the focused emission light spot 54 neatly moves over imaging plane 56. The same holds, respectively, for the reflective points of the illumination and emission light on the y-axis scanning mirrors 20a and 20b. If required, these points may be “optically” positioned in the focal plane of the scan lens 26 and re-scan lens 50, respectively, using relay optics known in the art. In the depicted embodiment, relay lenses 22a and 22b are configured to optically position the illumination light's reflective point on the y-axis scanner 20a in the focal plane of scan lens 26 and relay lenses 22c and 22d to optically position the illumination light's reflective point on the y-axis scanner 20b in the focal plane of re-scan lens 50. To summarize, both the reflective point on the first reflective surface 24a and the reflective point on the y-axis scanning system 20a are preferably in a conjugate plane of the back focal plane of the scan lens 26. Also, both the reflective point on the second reflective surface 24g and the reflective point on the y-axis scanning system are preferably in a conjugate plane of the back focal plane of the re-scan lens 50.

In the depicted embodiment, the re-scan microscope system 10 is configured to move the illumination light spot 34 over and/or through the sample 32 at a first velocity, v₁, and move the emission light spot 54 over the imaging plane at a second velocity, v₂, such that the second velocity is different from, preferably higher than, a baseline velocity. The baseline velocity is defined as the first velocity multiplied by the optical magnification of the re-scan microscope system.

In the depicted embodiment, the microscope system 10 comprises an objective 30 configured to gather the emission light 46 from the sample 32 and focus the emission light 46 on a primary image plane 27 of the re-scan microscope system 10. In the depicted embodiment, the detection optical system is configured to image images in the primary image plane 27 onto the imaging plane 56 of the imaging system 52.

The optical magnification of the re-scan microscope system 10 is independent of the respective velocities with which the illumination light spot 34 and the emission light spot 54 move over the sample resp, the imaging plane 56. The optical magnification of the re-scan microscope system may be understood to be determined by the optical magnification provided by the combination of objective 30 and tube lens 28, referred to as M_{micr} in De Luca, and the optical magnification M₂ of the detection optical system. The optical magnification of the detection optical system is determined by scan lens 26, relay lenses 22a-22c, lenses 40a and 40b and re-scan lens 50. Assuming that the relay lenses 22a-22d have equal focal lengths, the optical magnification M₂ of the detection optical system is given by

M₂=(f₄₀ₐ×f₅₀)/(f₂₆×f_{40b}), wherein f₄₀ₐ denotes the focal length of lens 40a, etc.

It should be appreciated that the velocity of the illumination light spot's image in primary image plane 27, v_{1P}, is given by the multiplication of the first velocity, i.e. the actual velocity of the illumination light spot 34 over and/or through the sample, with the optical magnification of the combination of objective 30 and tube lens 28, i.e. v_{1P}=v₁×M_{micr}.

The baseline velocity, v_{B}, in the depicted embodiment, assuming equal focal lengths of the relay lenses 22a-22d, is then given by v_{B}=v₁×M_{micr}×M₂.

In one embodiment, the second velocity is approximately twice as high as the baseline velocity, v₂≈2×v_{B}. This can for example be achieved by configuring the detection optical system such that it images an image in the primary image plane 27 onto the imaging plane 56 of the imaging system 52 with an optical magnification of approximately 0.5, M₂≈2 0.5. In this manner, the second velocity is twice as high as the baseline velocity if v_{1P} and v₂ are equal.

In the depicted embodiment, the system 10 comprises an aperture 42, such as a pinhole or slit, for passing emission light 46 and an optical system, in this example comprising lens 40a, for focusing the emission light 46 onto the aperture 42.

Further, the depicted embodiment comprises a data processing system 100 that comprises means for controlling the rotatable element and/or for controlling the y-axis scanning system 20a and/or 20b and/or for controlling the light source 11 and/or for controlling the imaging system 52.

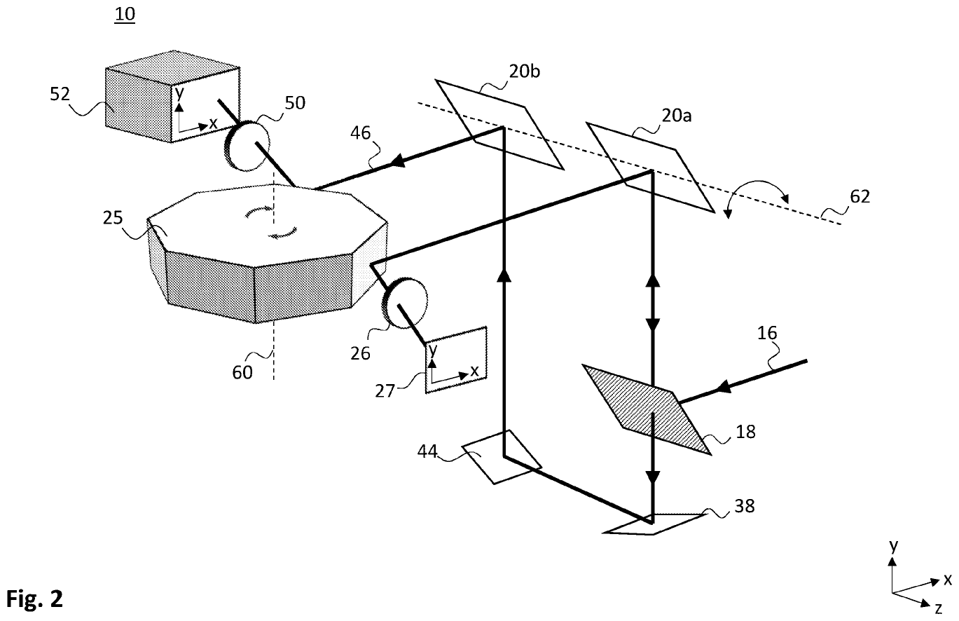

FIG. 2 shows an embodiment of the re-scan microscope system 10 in three dimensions. For clarity, the sample and optional further lenses after primary image plane 27 are not shown. The illumination light 16 is incident on dichroic mirror 18, which reflects the illumination light 16 towards y-axis scanning system 20a, in the depicted embodiment towards mirror 20a that is configured to rotate around axis 62. The illumination light 16 is subsequently incident on the rotatable element 25, in the depicted embodiment on polygon scanner 25, that is configured to infinitely rotate around rotational axis 60. Scan lens 26 subsequently focuses the illumination light onto the primary image plane 27. The further lens system that further focuses the illumination light on the sample is not shown. However, it should be appreciated that any movement of the illumination light over primary image plane 27 corresponds to a similar movement of the illumination light spot 34 over and/or through the sample 32. To illustrate, if the illumination light in plane 27 moves in the x-direction, then the illumination light spot 34 will move over and/or through the sample in the x-direction as well, yet with a lower velocity determined by the magnification of said further lens system.

The emission light 46 from the sample travels back from the sample to the rotatable element 25, which de-scans the emission light 46 so that a static emission light beam is formed that travels back to mirror 20a. Mirror 20a then reflects the emission light 46 to the dichroic mirror 18 that passes the emission light 46 so that the emission light is incident on static mirror 38 and static mirror 44 that are arranged to guide the emission light 46 to scanning mirror 20b. Scanning mirror 20b is also configured to rotate around axis 62. Preferably, the scanning mirrors 20a and 20b are configured to move synchronously. In one embodiment, a single y-axis scanning mirror may be used instead of the two scanning mirrors 20a and 20b.

After being reflected by mirror 20b, the emission light 46 is incident on a reflective surface of the rotatable element so that the emission light is re-scanned. Herewith, the emission light spot 54 is moved over imaging plane 56 of imaging system 52.

A rotation of the y-axis scanning mirror 20a causes the illumination light in plane 27 to move the in the y-direction as indicated and thus causes the illumination light spot 34 to move in the y-direction as well over and/or through the sample 32.

A rotation of the y-axis scanning mirror 20b causes the emission light spot 54 to move in the y-direction as indicated over the imaging plane 56.

The rotatable element 25 may thus be configured to move the illumination light spot 34 in a particular direction. The first velocity of the illumination light spot 34 as used herein may be understood to be the velocity component in this particular direction. Similarly, the rotatable element 25 may be configured to move the emission light spot 54 in a particular direction. The second velocity of the emission light spot 54 may be understood to be the velocity component in this particular direction.

In the depicted embodiment, the angle between the travel direction of the illumination light that is incident on the rotatable element and the travel direction of the emission light that is incident on the rotatable element for moving the emission light spot over the imaging plane is the same, i.e. the emission light 46 travels in the −x direction towards the rotatable element and the illumination light 16 also travels in the −x direction towards the rotatable element. Preferably, such angle is less than 90 degrees, preferably less than 60 degrees, more preferably less than 30 degrees.

In the depicted embodiment, the rotational axis is aligned with the y-axis as indicated on the bottom right. A radial surface may be understood to be a surface that is perpendicular to the rotational axis 60. In the depicted embodiment, any radial surface is thus parallel to the x-z plane as indicated on the bottom right.

Depending on the orientation of the y-axis scanners 20a and 20b and of the reflective surfaces of the rotatable element, the respective directions of the re-scanned emission light 46 and of the scanned illumination light 16 varies. In particular, the angle between a radial surface of the rotatable element and the direction of the re-scanned emission light depends on the orientation of the y-axis scanning mirror 20b, wherein the angle between a radial surface of the rotatable element and the direction of the scanned illumination light 16 depends on the orientation of the y-axis scanning mirror 20a. Preferably, these angles, during the scanning of the sample are at most 10 degrees.

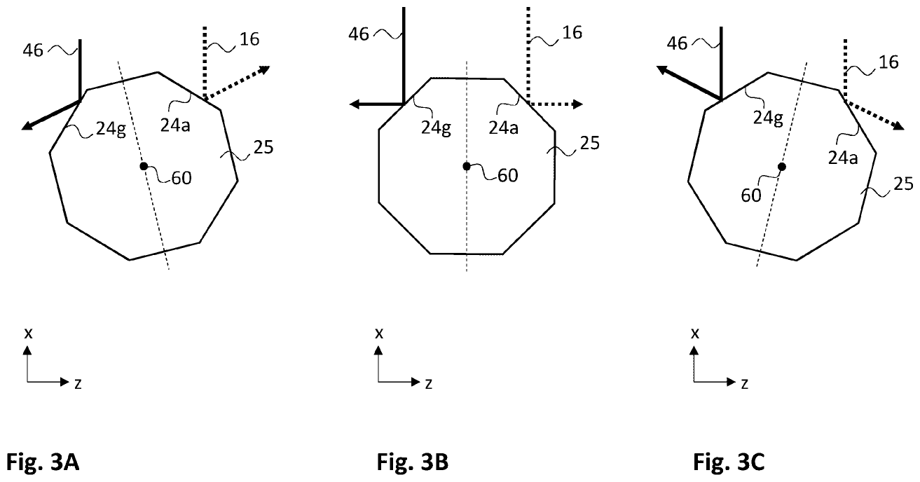

FIGS. 3, 4 and 5 show top views of the rotatable element at different time instances during a rotation. FIGS. 3A, 3B, 3C depict three respective time instances during the first time period throughout which the reflective surface 24a scans the illumination light 16.

FIG. 3 shows an embodiment wherein the re-scan microscope system 10 is configured such that, in use, during said first time period, the second reflective surface 24g reflects the emission light 46 and changes orientation during said first time period for moving the emission light spot 54 over the imaging plane 56.

For clarity, the de-scanning of the emission light 46 is not shown. Typically, the emission light 46, before passing a dichroic mirror 18, and the illumination light 16 travel along the same path, yet in opposite directions.

In the depicted embodiment, the illumination light 16 and emission light 46 travel in the same direction before being incident on the rotatable element 25, at least as viewed from the top as depicted.

Further, in the depicted embodiment, the rotatable element is configured to reflect the illumination light 16 in a first variable direction and to reflect the emission light 46 for moving the emission light spot over the imaging plane in a second variable direction. In the depicted embodiment, the scanned illumination light 16 and the re-scanned emission light 46 travel in substantially opposite directions, i.e. the angle between the travel directions is approximately 180 degrees. Preferably, this angle is larger than 90 degrees, preferably larger than 120 degrees, more preferably larger than 150 degrees so that the imaging system 52 and sample 32 can be positioned on either side of the rotatable element. This for example allows the re-scan microscope system to comprise only two fixed mirrors 38, 44, because no mirrors are required for guiding the scanned illumination light or re-scanned emission light to the sample resp, the imaging system.

FIGS. 3A, 3B and 3C illustrate that due to the rotation of the rotatable element 25, the orientations of the first and second reflective surfaces change causing the respective reflected light beams 16 and 46 to move as well.

Because the reflective surfaces 24 of the rotatable element 25 do not rotate around an axis that goes through the reflective surfaces themselves, but around a common axis 60, the respective positions of the reflective point of the illumination light 16 that is scanned and the reflection point of the emission light 46 that is re-scanned may slightly vary. However, the applicant has found that these variations do not deteriorate the formed images outside of acceptable limits. Optionally, these variations may be compensated for by means of appropriate post processing software.

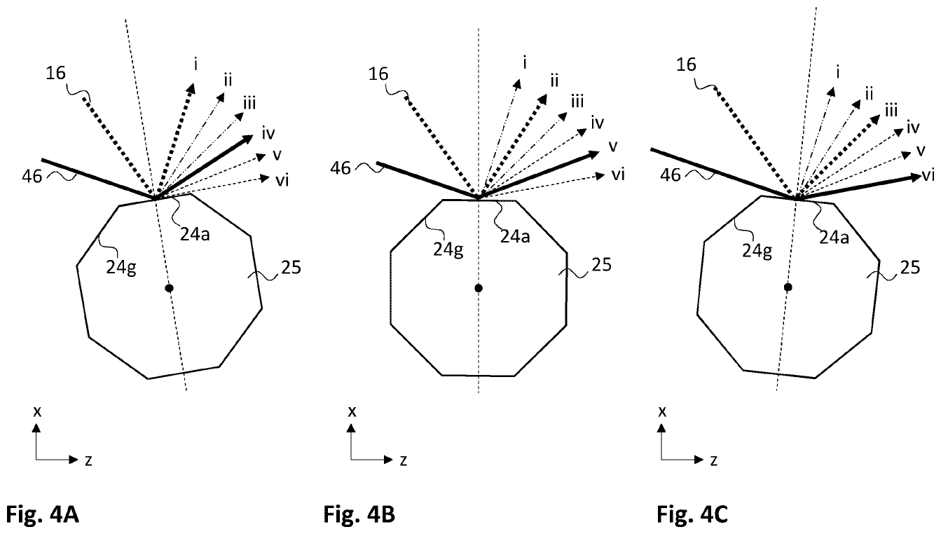

FIGS. 4A, 4B, 4C depicts three respective time instances during a first time period throughout which the reflective surface 24a scans the illumination light 16 and re-scans the emission light 46.

FIG. 4 shows an embodiment wherein the re-scan microscope system is configured such that, in use, during the first time period, the first reflective surface 24a reflects the emission light and changes orientation during said first time period for moving the emission light spot 54 over the imaging plane 56 and is configured such that, in use, during the rotation of the rotatable element 25. In this embodiment, a second reflective surface 24g reflects the illumination light 16 throughout a second time period and changes orientation during said second time period for moving the illumination light spot 34 over and/or through the sample 32. In the depicted embodiment, the re-scan microscope system is configured such that, in use, during said second time period, the second reflective surface 24g reflects emission light 46 and changes orientation during said second time period for moving the emission light spot 54 over the image plane 56. Here, the second time period occurs after the first time period, when the reflective surface 24g is positioned to receive the illumination light 16 and the emission light 46.

At respectively the first, second, third time instance (respectively shown in FIG. 4A. 4B, 4C), the first reflective surface 24a is oriented such that the scanned illumination light 16 respectively follows path (i), path (ii), path (iii) towards the sample 32 and such that re-scanned emission light 46 respectively follows path (iv), path (v), path (vi).

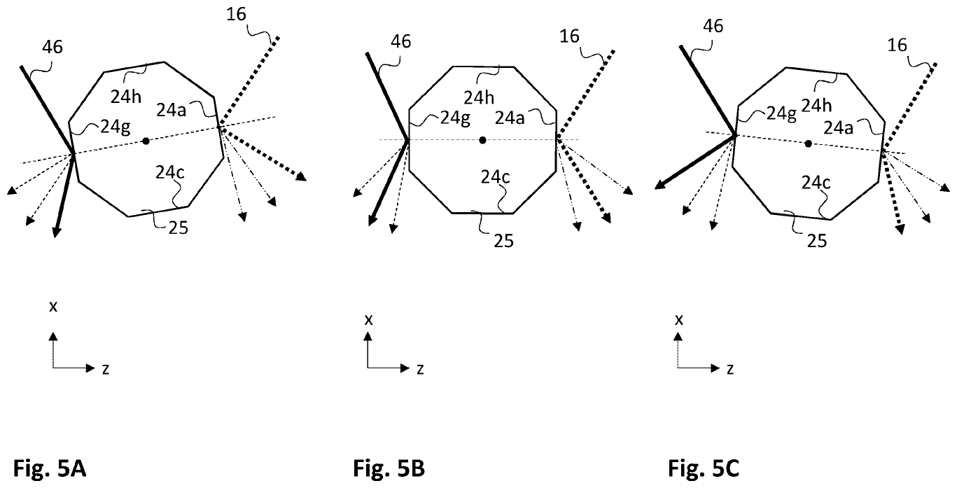

FIGS. 5A, 5B, 5C show three respective time instances during a first time period wherein a first reflective surface 24a reflects illumination light 16 and a second reflective surface 24g reflects emission light 46. In the depicted embodiment, reflective surfaces 24a and 24g are parallel, in particular oriented at 180 degrees with respect to each other. In this embodiment, the rotatable element comprises a third reflective surface 24h that is not parallel with surface 24a nor with surface 24g. Reflective surface 24h will, upon further rotation of the rotatable element, reflect the illumination light 16 for scanning, during a third time period. During the third time period, another surface, in this example reflective surface 24c, will reflect the emission light 46 for re-scanning.

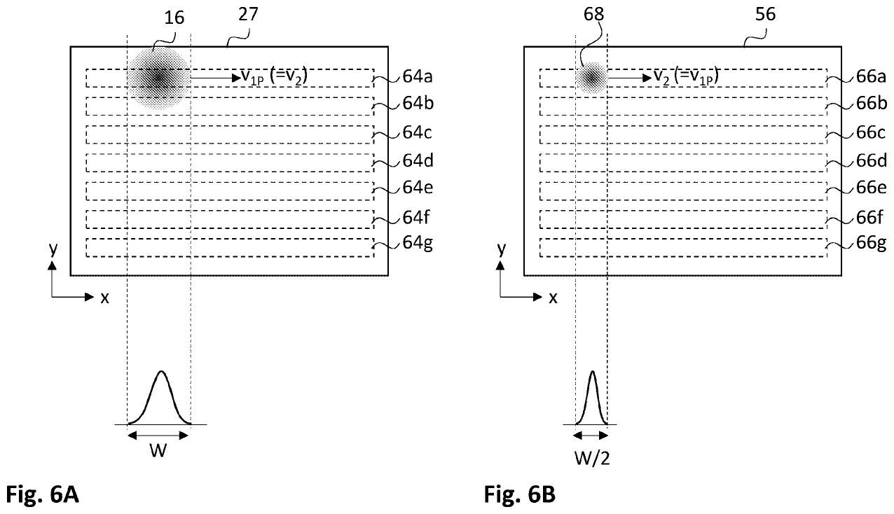

FIGS. 6A and 6B respectively show the movement of illumination light 16 in the primary image plane 27 and of the emission light spot 68 in the imaging plane 56.

When the illumination light 16 passes through plane 27 it is focused and has a point spread function having a width indicated by W. The emission light spot 68 is focused onto imaging plane 56 and the resulting emission light spot 68 has, in the depicted embodiment, a width W/2. As explained above, this difference in size may be due to the lenses in the detection optical system.

FIG. 6A shows that the illumination light 16 is scanned over the primary image plane 27 with a velocity in the x direction of v_{1P}. As a result, the illumination light spot 34 moves with a velocity over and/or through the sample in the x direction as well, yet with a lower velocity in the x direction due to the magnification caused by further lenses between the primary image plane 27 and the sample 32. In particular. FIG. 6A illustrates that the illumination light is scanned over the plane 27 so that the illumination light moves along several scan lines 64 over plane 27. As a result, the illumination light spot is also scanned line by line over and/or through the sample 32. Typically, the illumination light scans over each scan line 64 in the same direction, in this example from left to right. After the illumination light has scanned a line. e.g. line 64a, it is moved. e.g. by an incremental rotation of a y-axis scanner 20a, in the −y direction, so that the next line 64b can be scanned. Preferably, y-axis scanner moves incrementally in order to change the y-position of the illumination light and remains steady when the illumination light is scanned by the rotatable element in the x direction.

FIG. 6B shows that the emission light spot 68 is re-scanned over the imaging plane 56. Similarly, the emission light spot 68 is moved in the x direction by the rotatable element 25 over re-scan lines 66. Preferably, the illumination light 16 in primary image plane 27 and the emission light spot 68 on the imaging plane 56 move synchronously in the sense that the emission light spot 68 starts on a re-scan line 66 (on the left hand side) at the moment the illumination light 16 starts on a corresponding scan line 64 and that the illumination light 16 and emission light spot 68 reach the end of their respective lines at the same time.

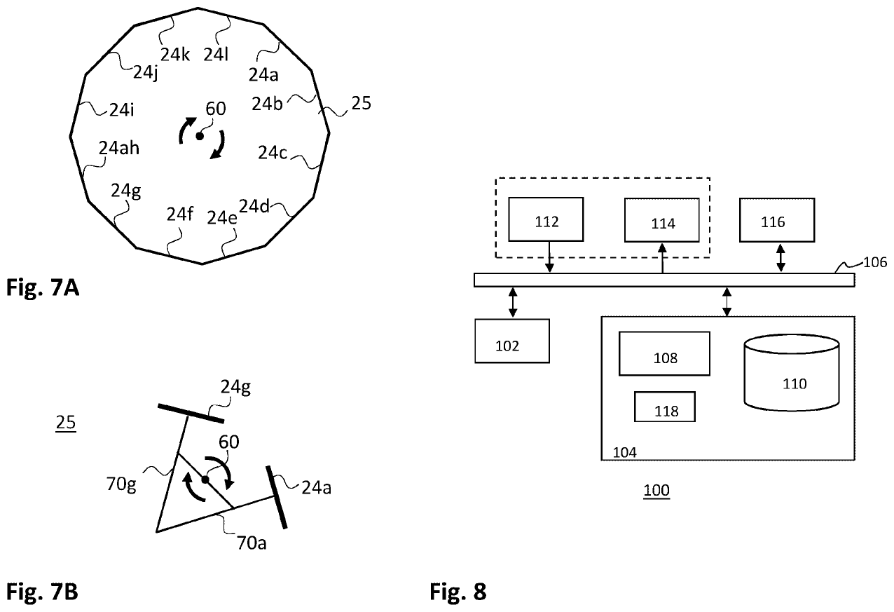

FIG. 7A shows a polygon scanner having 12 facets. In one embodiment, some of the facets may be reflective while other facets are non-reflective.

It should be appreciated that by increasing the number of facets, the number of scan lines that are written on the sample and imaging plane per rotation of the rotatable element increases. Herewith, the scan speed may be increased.

FIG. 7B shows yet another embodiment of the rotatable element 25, wherein two mirrors 24a, 24g are attached to the respective ends of two rods 70a, 70g. Again, the rotatable element is configured to rotate around rotational axis 60.

FIG. 8 depicts a block diagram illustrating an exemplary data processing system that may be used in a computing system as described with reference to FIG. 2.

As shown in FIG. 8, the data processing system 100 may include at least one processor 102 coupled to memory elements 104 through a system bus 106. As such, the data processing system may store program code within memory elements 104. Further, the processor 102 may execute the program code accessed from the memory elements 104 via a system bus 106. In one aspect, the data processing system may be implemented as a computer that is suitable for storing and/or executing program code. It should be appreciated, however, that the data processing system 100 may be implemented in the form of any system including a processor and a memory that is capable of performing the functions described within this specification.

The memory elements 104 may include one or more physical memory devices such as, for example, local memory 108 and one or more bulk storage devices 110. The local memory may refer to random access memory or other non-persistent memory device(s) generally used during actual execution of the program code. A bulk storage device may be implemented as a hard drive or other persistent data storage device. The processing system 100 may also include one or more cache memories (not shown) that provide temporary storage of at least some program code in order to reduce the number of times program code must be retrieved from the bulk storage device 110 during execution.

Input/output (I/O) devices depicted as an input device 112 and an output device 114 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 8 with a dashed line surrounding the input device 112 and the output device 114). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 116 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 100, and a data transmitter for transmitting data from the data processing system 100 to said systems, devices and/or networks. Modems, cable modems, and Ethernet cards are examples of different types of network adapter that may be used with the data processing system 100.

As pictured in FIG. 8, the memory elements 104 may store an application 118. In various embodiments, the application 118 may be stored in the local memory 108, the one or more bulk storage devices 110, or apart from the local memory and the bulk storage devices. It should be appreciated that the data processing system 100 may further execute an operating system (not shown in FIG. 8) that can facilitate execution of the application 118. The application 118, being implemented in the form of executable program code, can be executed by the data processing system 100. e.g., by the processor 102. Responsive to executing the application, the data processing system 100 may be configured to perform one or more operations or method steps described herein.

In one aspect of the present invention, the data processing system 100 may represent control module for controlling the re-scan microscope system as described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive. ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 102 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A re-scan microscope system for forming an image of a sample, comprising:
an illumination optical system configured to direct, and optionally focus, illumination light at the sample therewith providing an illumination light spot at the sample, the illumination light spot causing emission light from the sample;
a detection optical system configured to focus at least part of the emission light onto an imaging plane of an imaging system herewith causing an emission light spot on the imaging plane; and
a rotatable element for, when rotating, moving the illumination light spot over and/or through the sample and simultaneously moving the emission light spot over said imaging plane of the imaging system, wherein the rotatable element comprises at least two non-parallel reflective surfaces.

2. The re-scan microscope system according to claim 1, wherein the rotatable element is configured to rotate over an angle of at least 90 degrees about an axis of rotation.

3. The re-scan microscope system according to claim 1, wherein the rotatable element comprises a first reflective surface and a second reflective surface, and wherein
the re-scan microscope system is configured such that, in use, during a rotation of the rotatable element, the first reflective surface reflects the illumination light throughout a first time period and changes orientation during said first time period for moving the illumination light spot over and/or through the sample.

4. The re-scan microscope system according to claim 3, wherein the re-scan microscope system is configured such that, in use, during said first time period, the second reflective surface reflects the emission light and changes orientation during said first time period for moving the emission light spot over the imaging plane.

5. The re-scan microscope system according to claim 4, wherein the re-scan microscope system is configured such that, in use, during the rotation of the rotatable element, the second reflective surface reflects the illumination light throughout a second time period and changes orientation during said second time period for moving the illumination light spot over and/or through the sample and configured such that, during said second time period, a further reflective surface of the rotatable element reflects the emission light and changes orientation during said second time period for moving the emission light spot over the imaging plane.

6. The re-scan microscope system according to claim 3, wherein the re-scan microscope system is configured such that, in use, during said first time period, the first reflective surface reflects the emission light and changes orientation during said first time period for moving the emission light spot over the imaging plane and such that, in use, during the rotation of the rotatable element, the second reflective surface reflects the illumination light throughout a second time period and changes orientation during said second time period for moving the illumination light spot over and/or through the sample.

7. The re-scan microscope system according to claim 6, wherein the re-scan microscope system is configured such that, in use, during said second time period, the second reflective surface reflects emission light and changes orientation during said second time period for moving the emission light spot over the image plane.

8. The re-scan microscope system according to claim 1, wherein
the rotatable element comprises a rotatable polygon scanner comprising a plurality of reflective facets, wherein the first reflective surface is a first facet of the plurality of reflective facets and the second reflective surface is a second facet of the plurality of reflective facets.

9. The re-scan microscope system according to claim 1, wherein
the re-scan microscope system is configured to move the illumination light spot over and/or through the sample at a first velocity and move the emission light spot over the imaging plane at a second velocity, such that the second velocity is different from a baseline velocity, wherein
the baseline velocity is defined as the first velocity multiplied by the optical magnification of the re-scan microscope system.

10. The re-scan microscope system according to claim 16, wherein the second velocity is approximately twice as high as the baseline velocity.

11. The re-scan microscope system according to claim 9, comprising
an objective configured to gather the emission light from the sample and focus the emission light on a primary image plane of the re-scan microscope system, wherein
the detection optical system is configured to image images in the primary image plane onto the imaging plane of the imaging system, preferably with an optical magnification of approximately 0.5.

12. The re-scan microscope system according to claim 1 that is configured such that, in use, an angle between a travel direction of the illumination light that is incident on the rotatable element and a travel direction of the emission light that is incident on the rotatable element for moving the emission light spot over the imaging plane is less than 90 degrees.

13. The re-scan microscope system according to claim 1, wherein the rotatable element is configured to reflect the illumination light in a first variable direction and to reflect the emission light for moving the emission light spot over the imaging plane in a second variable direction, wherein the angle between the first and second variable direction is larger than 90 degrees.

14. The re-scan microscope system according to claim 1, wherein the system comprises an aperture configured to pass emission light and an optical system for focusing the emission light onto the aperture.

15. A method for forming an image of a sample using a re-scan microscope system, the re-scan microscope system comprising
an illumination optical system for directing, and optionally focusing, illumination light at the sample therewith providing an illumination light spot at the sample, the illumination light spot causing emission light from the sample, and the re-scan microscope system comprising
a detection optical system focusing at least part of the emission light onto an imaging plane of an imaging system herewith causing an emission light spot on the imaging plane, and
a rotatable element comprising at least two non-parallel reflective surfaces, and in that the method comprises
rotating the rotatable element for moving the illumination light spot over and/or through the sample and simultaneously moving the emission light spot over said imaging plane of the imaging system.

16. The re-scan microscope system according to claim 9, wherein the second velocity is higher than the baseline velocity.

17. The re-scan microscope system according to claim 11 wherein the detection optical system is configured to image images in the primary image plane onto the imaging plane of the imaging system with an optical magnification of approximately 0.5.

18. The re-scan microscope system according to claim 12 wherein the imaging plane is less than 60 degrees.

19. The re-scan microscope system according to claim 18 wherein the imaging plane is less than 30 degrees.

20. The re-scan microscope system according to claim 13 wherein the angle between the first and the second variable direction is larger than 120 degrees.
